(19) United States
(12) Patent Application Publication
(10) Pub. No.: US 2022/0095603 A1
(43) Pub. Date: Mar. 31, 2022

(54) HYDRO CUTTING TOOLS

(71) Applicant: Dustin Dishaw, Crystal Falls, MI (US)

(72) Inventor: Dustin Dishaw, Crystal Falls, MI (US)

(21) Appl. No.: 17/479,292

(22) Filed: Sep. 20, 2021

Related U.S. Application Data
(60) Provisional application No. 63/085,802, filed on Sep. 30, 2020.

(51) Int. Cl. A01M 7/00; A01M 21/02; A01M 21/04

(52) U.S. Cl. CPC A01M 7/0046; A01M 21/043; A01M 21/02

(57) ABSTRACT

Disclosed herein is a hydrolopper system comprising a herbicide reservoir and pump coupled using a supply line to a hydrolopper tool. Herbicide inside the herbicide reservoir is pumped through the supply line to a first spray head positioned at a distal end of the hydrolopper tool. The hydrolopper tool comprises a blade arm opposed to a landing arm extending from a from a first drive arm and a second drive arm. Closing of the drive arms causes consequent closure between a cutting jaws portion for cutting of vegetation. In some forms, the feedline travels through a cannula of a drive arm, whereas in other forms, the feedline is disposed on the outside of a drive arm. Herbicidal flow rate is controlled by a flow control valve.

### CROSS REFERENCE TO RELATED APPLICATIONS

This application claims priority to Provisional Patent Application No. 63/085,802 filed Sep. 30, 2020, the entire disclosure of which is hereby incorporated by reference and relied upon.

### BACKGROUND OF THE INVENTION

### Field of the Invention

The invention relates generally to cutting tools with liquid dispensers, and more particularly to cutting tools with integrated herbicide sprayers. In one form, the vegetation cutting tools with integrated herbicide sprayers are called hydroloppers.

### Description of Related Art

Related art includes the following U.S. patents and applications: 02726484 and 02747330-Simpkins discloses a pump in the handle of the shears that is manually activated by squeezing of the handles, 02730838-Wilson discloses a spring loaded valve integrated in the handle that opens to allow flow of chemicals each time the handles are closed, 05606822-Dearhammer utilizes an exposed resilient chemical-holding element in the cutting plane of the blades such that the element makes contact with the plant, 02951314-Laughlin discloses a rather complex wheeled lawn tool with chemical applicator, 08181351 and 08621752-Brim's disclosure utilizes a storage tank within one of the handles of a hand pruner with a squeezable rubber bulb that acts as a plunger to draw a chemical from the tank and force it out through a distribution conduit, 00773743-VonHoffman utilizes a rubber tube inside the handles of the shears to create a pumping action each time the shears are closed, 20110239826A1-Swayne discloses an open ended wrench operable to lubricate rusted fasteners during removal by operation of a pressure bulb in one handle, 06128850-Duffy discloses herbicide wafers held on to a vegetation cutting blade, 02600540-Johnson discloses power operated pruning shears having a double-acting plunger or piston valve unit incorporated in a cylinder along the side of the tools handgrip for opening and closing the shears, 20160157426A1-Ledehuhr discloses a hedge trimmer having an elongate fibrous member that encompasses a fill pipe supplying chemicals to the fibrous member, 05822968-Savala discloses an elongate garden tool such as a rake that has a reservoir available to disperse chemicals by activation of a handle on the rake, 03002319-Laughlin discloses a hand operated weed destroyer that is absent of a cutting aspect, 02789396-Jernlander discloses a liquid dispensing system with a supply tank carried on the user's back and utilizes a single cutting blade to assist with trimming when necessary, and 20030213132A1-Frazer who once again discloses a bulb like pump at the back of one of the instruments handles to dispense chemicals while using clippers. Competitors in this market also include the Hypo-Hatchet® Tree Injector that injects a herbicide when striking the tree with hatchet like device.

What is needed is a system that includes leveraged vegetation cutters having an integrated system for dispensing herbicides under pressure as a spray on invasive plants for the simultaneous action of cutting and spraying herbicide using favorable ergonomics.

### SUMMARY OF THE INVENTION

Disclosed herein are devices that overcome the shortcomings of the prior art. Included are various novel forms of a system, referred herein as a hydrolopper system, for cutting vegetation with simultaneous application of herbicide.

In one form, a hydrolopper system comprises a vegetation cutting tool in the form of a lopper comprising an integrated herbicide sprayer and referred to herein as a hydrolopper or hydrolopper tool.

In one form, a hydrolopper system presents a two-in-one solution that reduces the work involved in cutting plant life and applying herbicides.

In one form, a hydrolopper system is a two-in-one herbicidal treatment that removes both herbaceous and woody-stem invasive plants.

In one form, the devices as part of a hydrolopper system are easy-to-use, quick, and ergonomically beneficial.

In one form, a hydrolopper tool comprises a first arm jaw and an opposed second arm jaw.

In one form, the first arm jaw comprises a jog section to offset a distal portion of the first arm jaw.

In one form, disposed on a distal portion the first arm jaw is a landing arm.

In one form, the landing arm has a substantially flat landing arm face for abutment of the blade edge when lopping vegetation.

In one form, opposed cut edges are utilized on distal portions of the first arm jaw and second arm jaw.

In one form, the arm jaws comprise an arm stem extending proximally and can be narrowed for fixation to a respective first drive arm and second drive arm.

In one form, the first drive arm and second drive arm comprise respective a first handle and a second handle disposed on and over a proximal end of the drive arms.

In one form, a linkage system is utilized between the first arm jaw and second arm jaw for the transmission of leveraged forces for cutting vegetation applied by a user on the first handle and second handle.

In one form, a medial force applied to the first drive arm and second drive arm leverages a cut edge towards a landing arm face thereby cutting vegetation positioned therebetween.

In one form, a medial force applied to the first drive arm and second drive arm leverages two opposed cut edges towards each other thereby cutting vegetation positioned therebetween.

In one form, the first drive arm and second drive arm are approximately 21.5 inches long and are preferably in a range of 17.5 inches to 25.5 inches long or in a range 20 inches to 23 inches long.

In one form, a plurality of threaded fasteners are utilized in assembly of the cutting jaws portion.

In one form, a portion of the threaded fasteners are substituted with welds or other fixation means known in the art to fix various parts together.

In one form, at least one of the first drive arm and second drive arm are of a solid cross-section.

In one form, at least one of the first drive arm and second drive arm is manufactured of wood.

In one form, the first drive arm comprises a first arm cannula extending through the first drive arm along an axis-A.

In one form, the second drive arm comprises a second arm cannula extending from end to end along an elongate axis.

In one form, a feed line is utilized to carry the flow of herbicide from a proximal end to a distal end of the hydrolopper.

In one form, at least a portion of the feed line of the hydrolopper is housed within the first arm cannula of the first drive arm.

In one form, a portion of the herbicidal sprayer such as the feedline of the hydrolopper is disposed on a drive arm outer surface rather than housed within the first arm cannula.

In one form, a flow control valve is substantially housed within the first arm cannula.

In one form, a flow control valve is disposed on a drive arm outer surface.

In one form, a supply line is utilized to carry the flow of herbicide between a herbicide reservoir and pump to the feed line.

In one form, a flow control valve is positioned within a segment of the supply line proximal the first drive arm.

In one form, one or more of a proximal line support, a midline support, and a distal line support are utilized to hold the feed line within the first arm cannula.

In one form, the feed line is coupled with the supply line that draws herbicide from a herbicide reservoir.

In one form, the herbicide reservoir has a reservoir cap that can be removed for refilling the herbicide reservoir with herbicide.

In one form, a flow control valve interrupts one or more of the supply line and feed line to control release of herbicide.

In one form, the flow control valve comprises a knob for manually adjusting the flow of herbicide.

In one form, the flow control valve is set to shut off the flow of herbicide.

By using the devices disclosed herein, any commercial pesticide applicator, forester, landscaper, or do it yourself gardener is provided with an effective solution for treating invasive plants using a two in one solution of herbicidal treatment.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a distal end perspective view of a hydrolopper;

FIG. 2 depicts an exploded perspective view of the jaws of the hydrolopper depicted in FIG. 1;

FIG. 3 depicts an exploded perspective view of the hydrolopper depicted in FIG. 1;

FIG. 4 depicts a front view of a first arm jaw, first spray head, and first drive arm of a hydrolopper;

FIG. 5 depicts a front perspective view of a hydrolopper with a flow control valve positioned and fixed over a portion of a first drive arm;

FIG. 6 depicts a bottom perspective view of a hydrolopper with a flow control valve positioned proximal to the first drive arm;

FIG. 7 depicts a perspective view of a hydrolopper system including a hydrolopper tool with first spray head having supply from a herbicide reservoir and pump.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

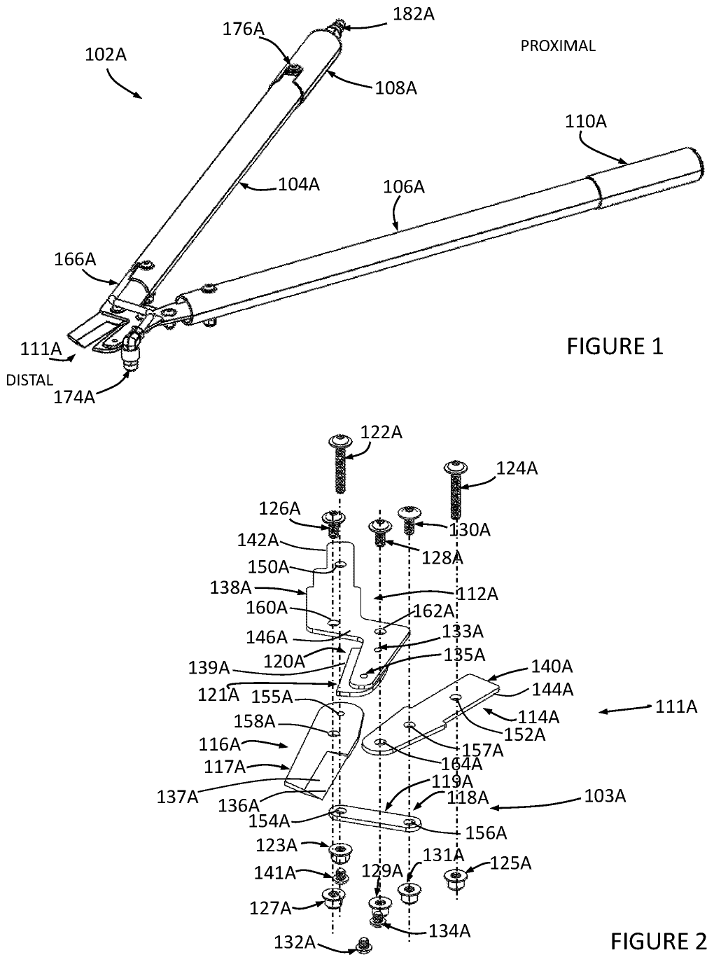

FIGS. 1-3 illustrates a preferred embodiment of a lopper tool comprising an integrated herbicide sprayer termed herein as a hydrolopper. In this embodiment, the hydrolopper tool 102A comprises a cutting jaw portion 111A which in this embodiment comprises a first arm jaw 112A having a plate like first arm jaw body 138A, a narrowed first jaw stem 142A and a second arm jaw 114A having a plate like second arm jaw body 140A, a narrowed second jaw stem 144A and whereby through a linkage system 103A is utilized to create a leveraged vegetation cutting tool. Second drive arm 106A is in the form of an elongate tube with second arm cannula 204A therethrough along axis-C and is fixed at second jaw stem 144A of second arm jaw 114A by second fastener 124A through second arm hole 152A and second nut 125A. First drive arm 104A is also in the form of an elongate tube with drive arm outer surface 105A. The first drive arm 104A comprises a first arm cannula 203A defined by cannula surface 205A extending therethrough along axis-A. In some embodiments, such as in FIG. 5, the drive arms are not cannulated. The first drive arm and second drive arm are approximately 21.5 inches long in this embodiment (FIG. 1) and preferably range in other embodiment between of 17.5 inches to 25.5 inches long or in a range 20 inches to 23 inches long.

The first drive arm is fixed at a distal end to first arm jaw 112A through first arm hole 150A by first fastener 122A and first nut 123A. A blade arm 116A comprises a plate like blade arm body 117A with a blade face 137A that tapers down to blade edge 136A. A blade pivot hole 158A extends through the blade arm body 117A and is aligned and secured by third fastener 126A and third nut 127A with primary pivot hole 160A that extends through the first arm jaw body 138A. A lever link 118A having a flat elongate lever link body 119A comprises at opposing ends a first link hole 154A and a second link hole 156A whereas first link hole 154A is aligned with first link aperture 155A of blade arm 116A and is secured with eighth fastener 141A to serve as a pivot point in the linkage. Second link hole 156A is aligned with second link aperture 157A of second arm jaw 114A and secured with fifth fastener 130A and fifth nut 131A. The lever link is therefore pivotably connected between the first arm jaw and the second arm jaw. The first arm jaw 112A with second pivot hole 162A therethrough near jog section 146A and second arm jaw 114A with second jaw hole 164A therethrough at a distal end are aligned and secured with fourth fastener 128A and fourth nut 129A. In some embodiments, threaded fasteners can be substituted with other means such as rivets or welds as deemed appropriate.

First arm jaw body 138A comprises a jog section 146A to offset the distal portion of the first arm jaw body 138A which has a plate referred to as a landing arm 120A fixed to one side of it with seventh fastener 134A in first jaw hole 133A and sixth fastener 132A in second jaw hole 135A. The landing arm comprises a plate like landing arm body 121A having a landing arm face 139A for substantially perpendicular abutment of blade edge 136A when lopping vegetation such as a branch of an invasive shrub through action of approximating first handle 108A on proximal end of first drive arm 104A with second handle 110A on proximal end of second drive arm 106A. In this embodiment, these forces drive the lever link to pivot the blade arm toward and abut the landing arm.

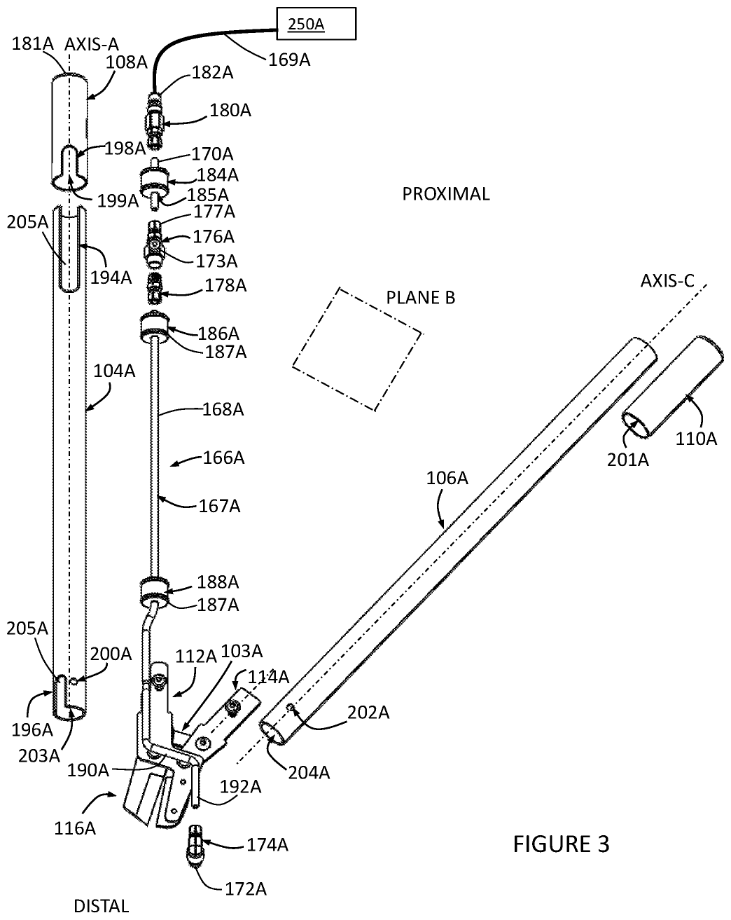

FIG. 3 illustrates in greater detail a portion of a hydrolopper system. In this embodiment, a portion of the herbicide sprayer is partially housed within the first arm cannula 203A of first drive arm 104A. A hose interface 182A, couples with supply line 169A and draws herbicide from a herbicide reservoir 250A for distribution through feedline 166A and eventually disperses it through first spray head 174A on the vegetation.

A first drive arm feed recess 196A at a distal end of the first drive arm 104A provides space for the distal line 168A of the feed line 166A to exit from the first arm cannula 203A and cross to an opposing side of the cutting jaws portion 111A. Similarly, first drive arm control recess 194A along with the first handle control recess 198A in first handle 108A provides access to the flow control valve 176A by the user whom controls the rate of flow upon manual rotation of flow control knob 173A on the flow control valve 176A. A first handle cavity 199A within first handle 108A is sized for the proximal end of first drive arm 104A to be seated at least partially therein. Similarly, a second handle cavity 201A within second handle 110A is sized for housing the proximal end of second drive arm 106A to be seated therein. An entry window 181A on the proximal end of first handle 108A provides for passage of hose interface 182A extending from proximal line coupler 180A. The proximal line coupler 180A is coupled with proximal line 170A of feed line 166A which in turn is coupled with first line coupler 177A of flow control valve 176A. The distal end of flow control valve 176A is coupled with second line coupler 178A which at a distal end is coupled with the proximal end of distal line 168A of feed line 166A.

As further depicted in FIG. 3, all portions of feed line 166A comprise a feed line body 167A having an internal cannula serving for the leak-free flow of herbicide from a herbicide reservoir. The distal line 168A of feed line 166A, in this embodiment, is substantially straight until the distal portion where it begins to jog just before exiting the distal end of first arm cannula 203A and utilizes a larger distal line jog 190A substantially following the jog section 146A of first arm jaw 112A before again extending distally at distal line extension 192A and where it is coupled at its terminal end with first spray head 174A and can be held by a spray head mount. It is recognized that those skilled in the art can contemplate other pathways for the feedline to travel towards the distal end. Herbicide pumped through the distal line 168A and first spray head 174A then exits first spray nozzle 172A which in this embodiment directs the herbicide substantially perpendicular to plane B which is defined by axis-A and axis-C of first drive arm 104A and second drive arm 106A. A proximal line support 184A, a mid-line support 186A, and a distal line support 188A are spaced throughout the first drive arm and support the feed line 166A within a support cannula 185A centered within the line supports. In this embodiment, the line supports are substantially barrel shaped with an outer line support surface 187A that has a portion sized for fit against the cannula surface 205A of the first arm cannula 203A but are not limited to this shape. A first handle hole 200A is situated at a distal end of first drive arm 104A and a second handle hole 202A is situated at a distal end of second drive arm 106A whereas each of these holes provide for fastener fixation to respective stems of first arm jaw 112A and second arm jaw 114A.

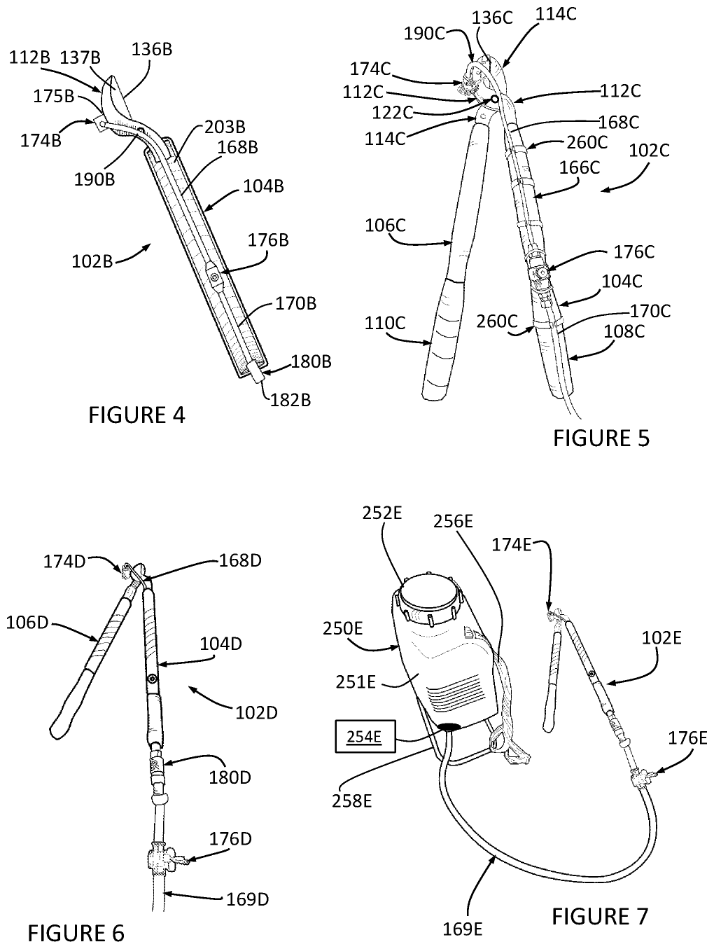

FIG. 4 depicts one half of another hydrolopper tool 102B embodiment illustrating the first arm jaw 112B with blade face 137B tapering to blade edge 136B. Here, first drive arm 104B is fixed to the first arm jaw 112B. Traveling down the first arm cannula 203B is the feed line with the proximal line 170B and distal line 168B illustrated. At a distal end of the feed line is a first spray head 174B. One or more of the spray head and distal end of the feed line can be secured by a spray head mount 175B to the first arm jaw. At a proximal end is hose interface 182B extending from proximal line coupler 180B. A flow control valve 176B controls the flow of herbicide through the feed line.

FIG. 5 depicts a prototype hydrolopper tool 102C. In this case, the first drive arm and the second drive arm have a solid cross-section and in some cases can be manufactured of wood although other materials can be used. In this embodiment, the distal line 168C of feed line 166C is fastened or otherwise fixed with line fasteners 260C to an outside surface of first drive arm 104C as the feed line extends towards first arm jaw 112B. The proximal line 170B is also fastened or otherwise fixed with a line fastener using fixation means known in the art to an outside surface of the first drive arm 104C. A flow control valve 176C situated between the distal and proximal lines and mounted to first drive arm 104B, controls the flow of herbicide to first spray head 174C. This configuration is useful for hydrolopper construction utilizing non-cannulated drive arms. This Figure also illustrates a cutting jaws portion 111C absent of a lever link and absent a blade arm whereas both of the first arm jaw 112C and second arm jaw 114C actively engage the vegetation by force using at least one blade edge 136C on one of the respective arm jaws.

FIG. 6 depicts a hydrolopper tool 102D prototype that has been built and tested by the inventor. Noted on the Figure are features identified previously in FIG. 1. It is notable that the flow control valve 176D in this embodiment is located in-line of supply line 169D proximal to proximal line coupler 180D. FIG. 7 depicts a hydrolopper system 100E with herbicide reservoir and pump 250E coupled to the hydro lopper tool 102E by supply line 169E. The herbicide pump 254E, drawing herbicide from the herbicide reservoir 251E creates a pressure such that the herbicide is pressurized for eventual spraying from the first spray head. The reservoir can be refilled by removal of a reservoir cap 252E. Herbicide inside the reservoir is pumped through the supply line 169E to the first spray head 174E positioned at the distal end of the hydrolopper tool 102E. Carry straps 256E, such as shoulder or waist straps can be used for low effort carrying of the reservoir and pump 250E. A stand 258E mounted to an inferior end of the reservoir can be used to hold the reservoir upright and elevated.

It is noted that the terms “substantially” and “about” and “generally” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A system for cutting vegetation and dispensing herbicide comprising:
an elongate first drive arm and an opposed second drive arm;
a first arm jaw;
a second arm jaw;
a blade edge;
said first arm jaw extending from said first drive arm;
said second arm jaw extending from said second drive arm;
at least one of a fastener or rivet operable as a pivot between said first arm jaw and said second arm jaw;
a feed line;
a flow control valve;
a first spray head;
said flow control valve operable to control flow of a herbicide through said feedline;
said feed line terminating in said first spray head;
said feed line extending from a proximal end of said first drive arm;
said feed line terminating at a distal end of said first arm jaw; and
whereby said system is operable for simultaneous cutting of vegetation and dispensing of herbicide through said first spray head.

2. The system of claim 2 whereas said first spray head is positioned adjacent the distal end of said first arm jaw.

3. The system of claim 2 whereas said first spray head flow is directed perpendicular to a plane extending through axes of said first drive arm and said second drive arm.

4. The system of claim 1 further comprising:
a lever link;
whereby said lever link is pivotably connected between said first arm jaw and said second arm jaw.

5. The system of claim 1 further comprising:
a first arm cannula extending through the center axis of said first drive arm; and
whereby said feed line is substantially housed in said first arm cannula.

6. The system of claim 1 further comprising:
whereby said flow control valve is at least partially housed in said first arm cannula.

7. The system of claim 1 further comprising:
a drive arm outer surface on said first drive arm; and
whereby said flow control valve is secured to said drive arm outer surface of said first drive arm.

8. The system of claim 1 whereby said first drive arm and said second drive arm have a solid cross-section.

9. The system of claim 1 further comprising:
a supply line;
a herbicide reservoir;
said supply line coupled between said feed line and said herbicide reservoir; and
whereas said flow control valve is disposed within a portion of said feed line.

10. The system of claim 1 further comprising:
a supply line;
a herbicide reservoir;
said supply line coupled between said feed line and said herbicide reservoir; and
whereas said flow control valve is disposed within a portion of said supply line.

11. The system of claim 1 whereby said flow control valve comprises a flow control knob for manual adjustment of fluid flow through said flow control valve.

12. The system of claim 1 further comprising:
at least one of a proximal line support, a midline support, and a distal line support encircling said feed line within said first arm cannula.

13. The system of claim 1 further comprising:
a drive arm outer surface;
whereas said feed line is secured to said drive arm outer surface.

14. The system of claim 1 whereby said first drive arm and said second drive arm are between 17.5 and 25.5 inches in length.

15. The system of claim 1 further comprising:
a distal line jog in said feed line at a distal end.

16. The system of claim 1 further comprising:
a landing arm;
said landing arm comprising a flat landing arm face;
said landing arm fixed to a distal end of said first arm jaw.

17. The system of claim 14 further comprising:
a blade arm;
said blade arm pivotably fixed to said first arm jaw;
a sharpened blade edge on said blade arm;
whereby when leveraging said first drive arm and said second drive arm together, said blade edge abuts said flat landing arm face.

18. The system of claim 1 further comprising:
a herbicide reservoir;
carry straps;
whereby said carry straps are secured to said herbicide reservoir and operable to carry said herbicide reservoir on the back of a user.

19. The system of claim 1 further comprising:
a herbicide reservoir;
a reservoir cap;
whereby said reservoir cap is operable for removing to fill said reservoir with herbicide.

20. The system of claim 1 further comprising:
a herbicide reservoir;
a stand;
whereby said herbicide reservoir is held upright by said stand when set on a ground surface.
